(19) United States
(12) Patent Application Publication
(10) Pub. No.: US 2009/0247006 A1
(43) Pub. Date: Oct. 1, 2009

(54) NETWORK ACCESS POINT HAVING INTERCHANGEABLE CARTRIDGES

(75) Inventor: William H. Thompson, Pittsford, NY (US)

Correspondence Address: BASCH & NICKERSON LLP, 1777 PENFIELD ROAD, PENFIELD, NY, 14526, US

(73) Assignee: WI3, INC., NEW YORK, Pittsford, NY (US)

(21) Appl. No.: 12/357,053

(22) Filed: Jan. 21, 2009

Related U.S. Application Data
(60) Provisional application No. 61/022,629, filed on Jan. 22, 2008.

(51) Int. Cl. H01R 13/66

(52) U.S. Cl. 439/527

(57) ABSTRACT

Disclosed is multimedia system having at least one network access point comprising two discrete, but interrelated, components, a communications module and a device interface cartridge whereby in combination implement a network access point to accommodate via a medium. The interface cartridge is interchangeable to permit the access point to be customized to a desired application.

This application claims priority from the following Provisional Application, which is also hereby incorporated by reference in its entirety, “Multimedia Access Point Chassis Having A Backplane Connector”, by W. Thompson, Application No. 61/022,629, filed on Jan. 22, 2008.

Disclosed herein is an apparatus and method for providing a multimedia network access point, wherein a network access point includes a communications module to interact with various network media and further recognizes a node address and associated data packet to be subsequently passed to an application specific interface cartridge, connected therein, for decoding and processing.

### BACKGROUND AND SUMMARY

The need for reliable communication interconnections in industry, offices and the home has increased exponentially in recent years based on the utilization of computers as communication tools with remote servers, such as the case with the Internet, VoIP and cable TV, with all potentially residing within the same conductor. Furthermore, the proliferation of diverse protocols, topography, broadband and audio-visual applications has placed an unanticipated strain on one-to-one connectivity at the access point (also referred to herein as “AP”) in order to support a diversity of physical connection types and specifications. Today a network access point may be connected to either a computer, data terminal, modem, printer. monitor, camera, TiVo, TV, telephone, VCR, speakers, lights, appliances or the like and generally requires low voltage infrastructure wiring consisting of at least a coaxial cable, twisted pair cable, a fiber-optic cable, and possibly combinations thereof. Always having available the required access point connections at a network outlet is an expensive and monumental task—particularly when upgrading pre-existing wiring and networks. Additionally, numerous connector configurations and connector types, along with the aforementioned cabling or conduits, provides for a diverse set of possible combinations. For example, an end-user may require a standard registered jack (RJ) of the type used for telephone equipment, however within the same home or business, another access point might be required to support a coaxial connector, a fiber-optic cable connector, or yet even a non-specific style of connector. Further complicating these requirements are the diverse industry standards for terminating such connectors, each requiring different skills and tools. The requirement to couple to different types of termination schemes, while providing the desired in-wall connector, presents numerous challenges to the communications and consumer electronics industry at large.

Most often, in new construction, the network wiring is installed concurrently with the electrical wiring during the “rough framing” of the new facility, be it a residential or commercial building. Typically, during this rough-in phase the cables are cut, looped and placed within the rough-in enclosures, which are considered to be access point brackets for the purposes of this embodiment. Once the walls have been completed the appropriate connectors are then connected to the cables according to industry standards. In the case of pre-existing construction, a new and/or different consumer device connection often requires that a new cable be installed, which typically is a difficult and very labor intensive task. Consequently, the embodiments disclosed herein provide a simple and flexible means for tapping various types of multimedia analog or digital transmissions carried on any installed cable without requiring a change in the cable type, connector or enclosure.

Technology is evolving to allow various types of communications data and multimedia entertainment signals to coexist on a variety of transmission mediums. These innovations provide a practical solution to address the proliferation of diverse network specifications employing various medium conduits, such as category rated twisted pair, coaxial and fiber optic cables with various protocols including Ethernet, WiFi, Wireless, HD, USB and IEEE1394 (e.g., Firewire). The communications industry is now developing chipsets that enable this circuitry to be housed within or adjacent the pre-existing void of the typical low voltage access point enclosure. Such circuits are known to provide a plurality of network features from wired to wireless connections, including infrared and radio frequency, to protocol translation and encoding/decoding. One example of enclosure signal processing is disclosed in U.S. Pat. No. 6,108,331, entitled “SINGLE MEDIUM WIRING SCHEME FOR MULTIPLE SIGNAL DISTRIBUTION IN BUILDING AND ACCESS PORT THEREFORE” and U.S. Pat. No. 7,027,431 entitled “WIRELESS DEVICE CONNECTION IN SINGLE MEDIUM WIRING SCHEME FOR MULTIPLE SIGNAL DISTRIBUTION IN BUILDING AND ACCESS PORT THEREFOR,” to William H. Thompson, both having a common inventor with the instant application, and both hereby incorporated by reference in their entirety. As disclosed in the prior patents to Thompson, various types of signals are converted and/or carried as addressable data packets over a multitude of data transmission conduits and subsequently restored to their native mode by circuits contained within the local access point enclosure. An alternative example, of an active circuit housed within the enclosure, is the Wi-Jack™, available from Ortronics Inc., New London Conn., whereby WLAN technology is directly facilitated within the wall outlet enclosure. Another wall outlet circuit is essentially a Windows CE based client computer, known as Jack PC™, produced by Chip PC Technologies, Tirat Carmel, Israel, that supports terminal connectivity to a Citrix server.

The evolving diversity and transitional aspects of today's network connectivity have become a primary concern of the end user, due to a plurality of connectivity options that may exist from node to node within the same local area network. For example a single structure may contain twisted pair cabling for Ethernet or phones while coax cable is required for CATV and other video services. In addition the high-definition multimedia interface (HDMI) standard is being considered for applications within the LAN as a uniform interface for consumer electronics used in conjunction with a network. Therefore the instant disclosure is intended to address the various media requirements and thereby provide the appropriate hardware and software to adapt data transmissions and connectivity into a single network in accordance with device specific protocols.

Accordingly, the present disclosure is directed to providing network access points that that are essentially transparent to the type of medium and connector, in order to facilitate one or more dedicated connections to one or more in-house network cables, each of which may or may not encompass dissimilar cable types and associated connectors.

A Network Communications Module (herein referred as “NCM”), comprises at least one input in accordance with a specific medium type such as consisting of twisted pair, coax, fiber optics or even the power line, wherein a dedicated access point address is assigned for that specific node. The network communications module is of a size suitable to mount directly within a low voltage rough-in enclosure or high voltage enclosure in the power line medium application, that also serves as a mounting bracket for both the network communications module and a conventional access point faceplate. Circuit power is preferably derived from low voltage (e.g., 48 VDC) that is conducted within the LAN cabling (e.g., coax or twisted pair cable) and discriminated from the data stream within the network communications module. As an alternative, circuit power may derived directly from the power line medium application or an external low voltage power supply. The network communications module contains circuitry to allow for the transfer of data packets to and from the network which are subsequently decoded, processed and passed, via a high speed peripheral component interconnect (PCI), to an application interface cartridge (also referred to herein as an AIC).

Over the years the consumer electronics industry has produced a plurality of assorted connector types, including, but not limited to; USB, Firewire™, HDMI, Component Video, DVI, Type F, RJ45, RJ11 and RS232. An application interface cartridge essentially adapts the data packet received from the network communications module to accommodate device specific protocols, and data packet decoding. Given this extensive complement of access point output specifications, the AIC serves to eliminate connector perplexities by providing an array of application interface cartridges that not only provide for the device specific protocol, but also the native connection means and medium. The application interface cartridge may be configured to contain single or multiple connections.

The existence of a fixed location network communications module component allows a simplification of digital network setup and on-going maintenance functions. Each network communications module may be assigned a unique physical address, manually or self administered. Once the system infrastructure is configured at set-up, the assigned node address remains the “property” of the access point and is therefore exclusive to the network communications module and not to an attached peripheral device. Now a plurality of application interface devices can be subsequently interchanged within the network communications module, without requiring any administrative efforts to re-program the network communications module. It is further anticipated that the NCM may include address filters, converters, encoders, HDCP keys, receivers, transmitters, and other such devices that are required to process the packet stream. Where the conductor is photo-optics, the network communications module may also include a media converter that adapts an optical packet stream into an electrical packet stream, and vice versa. It is also contemplated that the signals may simply be “relayed”, albeit having been converted so as to include altered or additional information (e.g., change in address/routing information, change in header, etc.). In other words, converting the signals may include a media conversion and/or a mere change to the data itself as it is processed by the device.

The NCM consists of an input and output connector suitable for providing a data connection between the AIC transmitter node and the receiving AIC node. Furthermore the network communications module receives and transmits data packets from the LAN by handling the protocol conversions and data processing between the LAN and the application interface cartridge. In essence the network communications module handles the network centric electronics and firmware elements and co-exists within the access point with at least one of a variety of application interface cartridges. The appropriate application interface cartridge for the peripheral device is simply selected, inserted into, and electrically connected to, the forward facing cavity within the network communications module, which also serves as a chassis to position and secure one or more application interface cartridges. Each network communications module within the network is previously assigned a unique Media Access Control (MAC) address that is fixed to that node and adopted by the inserted application interface cartridge, thereby eliminating the need to reconfigure the node.

As previously discussed, conventional access point wall enclosure practices require that only a connector be wired and inserted within a faceplate, however, as noted above, the device connector is now an integral part of the AIC, accordingly only a standard utility power outlet faceplate is required to provide an aesthetic appearance.

Currently very limited network access point electronics and connectors have been housed within pre-existing low voltage enclosures, being less sophisticated than an ordinary electrical utility box, where the wires are simply hard wired and terminated into an access point connector or circuit board, absent any jack/plug configuration to the backbone. Accordingly, there is an evolving complexity to the access point wiring schemes which encumbers the network installation, as well as subsequent module interchangeability, because hard connections are not intuitive or standardized. The present disclosure describes an access point that provides a plug and play environment where one or more application interface cartridges can be interchanged at will without any wiring intervention or reconfiguration.

Requirements for an in-home network include high-speed data transfer for multimedia content, short-range connectivity for transfer to other devices, low power consumption due to limited current capacity, low complexity and cost due to market pricing pressures and alternative wired connectivity options. Accordingly a complement of interchangeable application interface cartridge configurations essentially provide for the entire gamut of consumer electronics network specifications, as well as any future configurations, at a acceptable cost to the end user. Although the application interface cartridges share a common footprint they are functionally distinct in both connectors and data management. For example, an HDMI application interface cartridge may be inserted into any network communications module to provide the direct connection of an HDTV to a Blu-Ray HD DVD player located in another room in the home. If, on the other hand, a connection for a USB hard drive is desired, the HDMI interface cartridge can be simply exchanged with a USB equipped interface cartridge. Notably, as technology and client needs evolve, so will the availability of specific AIC modules in order to allow the end-user to take advantage of technical evolution without any significant effort or cost. Further, to provide for the most efficient and feature expandable architecture the network communications module may have its programmable code stored in flash memory located in the application interface cartridge, to provide for a method to upgrade the functionality of the network communications module and thereby handle evolving ranges and capabilities of application interface cartridges.

It is therefore an object of the disclosed embodiments to provide an in-wall access point enclosure, that will securely accept the insertion of a access point electronics unit node consisting of a network communications module (motherboard) and any one of a plurality of application interface cartridge daughter boards that is retained within the module and arranged in a “piggy back” manner.

It is further an object of the disclosed embodiments to provide a free-standing (e.g., set-top box) docking station network communications module that will securely accept the insertion of one or more application interface cartridges.

It is another object of the disclosed embodiments to provide an in-wall enclosure that contains a network communications module identifying the node address of the access point that is exclusive of the attached network device.

It is an additional object to provide a gambit of application interface cartridges, each of which adapts to a different connectivity requirement of a network device.

It is another object of the disclosed embodiments that the application interface cartridge be suitable for use as the source of programming information in order to facilitate programming of the network communication module.

It is yet another object of the disclosed embodiments to provide an in-wall enclosure that substantially limits the infiltration and exchange of air from the outside environment.

It is another object of the disclosed embodiments to facilitate air flow into and about the electronics module for cooling.

It is also an object of the invention, in the absence of an network communications module access point electronics unit, to provide a “pass through” connection to the LAN

It is a further object of the disclosed embodiments to provide registration or alignment features (e.g., rails/slides) within the network communications module to accurately align the application interface cartridge within the network communications module.

Disclosed in embodiments herein is a network access point, comprising: an enclosure, at least one access point network communications module secured within the enclosure, at least one device specific adapter cartridge, of a multiplicity of cartridges, inserted within said network communications module; and, at least one physical medium conductor connected to the access point network communications module and arranged for connection to at least one other access point within a commonly shared backbone.

Also disclosed in accordance with the embodiments described herein is a method of creating an access point within a network, comprising: connecting an network communications module having a dedicated network address to said network via an interconnection cable; and inserting an application interface cartridge within the network communications module; to electrically engage the network communications module and thereby complete a network access point providing a device interface for connection of a user device to the network.

Also disclosed in accordance with the embodiments described herein is a network, including: a gateway device which accepts outside services such as those offered by CATV, Satellite TV and Telephone service providers; and transitions those signals onto the in-home network. The gateway may also provide the low voltage power source for the electronic network access points. Essentially, the gateway 200 acts as a portal to services provided by the service providers, and facilitates such services being transported to one or more network access points.

In another related embodiment other aspects of the disclosed embodiments, as will be described herein, are accomplished by providing an enclosure having an insertable backplane with at least two removable panels, whereby a module connector mounting insert can be substituted for at least one of the panels. Both the connector mounting insert and the knock out panel have retaining members that may be adjusted and removably inserted (e.g. resiliently deformable) to permit the backplane assembly to be easily disassembled and removed from and placed at various positions within the enclosure. One or more connector mounting inserts further includes an industry standard aperture that will accept at least one of many keystone style jacks. Accordingly, a network access point, comprising: an enclosure including a configurable and/or adjustable backplane, an aperture in the backplane for retaining at least one connector therein; and a device, plugging directly into the connector while being inserted within the enclosure, to provide an access point to a network

Other and further objects, features and advantages will be apparent from a reading of the following specification and by reference to the accompanying drawings forming a part thereof, wherein the examples of a preferred embodiments are given for the purposes of this disclosure.

### BRIEF DESCRIPTION OF THE DRAWINGS

FIG. 1 is an isometric view of the access point electronics modules assembled into a low voltage bracket;

FIG. 2 is an exploded isometric view of the faceplate, modules and bracket;

FIG. 3 is an isometric view of the application interface cartridge;

FIG. 4 is an isometric view of the network communications module;

FIG. 5 is a block diagram of the cartridge of FIG. 3 and the module of FIG. 4;

FIGS. 6-8 are isometric front views of a plurality of functionally discrete application interface modules;

FIG. 9 is an isometric view of a free-standing application interface module cradle;

FIG. 10 is an isometric view of a dual network access point;

FIG. 11 is a schematic of an exemplary multi-media distribution system;

FIG. 12 is an isometric exploded view of an alternative embodiment having a backplane mounted connector;

FIG. 13 is a perspective view of an alternative embodiment of the access point; and

FIG. 14 is an alternative view of the multimedia distribution system of FIG. 11.

The various embodiments described herein are not intended to limit the scope of the appended claims to those embodiments described. On the contrary, the intent is to cover all alternatives, modifications, and equivalents as may be included within the spirit and scope of the claims.

### DETAILED DESCRIPTION

As more particularly set forth below, the disclosed apparatus, systems and methods are intended to provide configurable access points (APs) for a network within a structure, facility, dwelling or the like. The following will be described in connection with preferred embodiments, however, the intent is to cover all alternatives, modifications, and equivalents as may be included within the spirit and scope of the embodiments described and defined by the appended claims. For a general understanding of the disclosed embodiments, reference is made to the drawings. In the drawings, like reference numerals have been used throughout to designate identical elements.

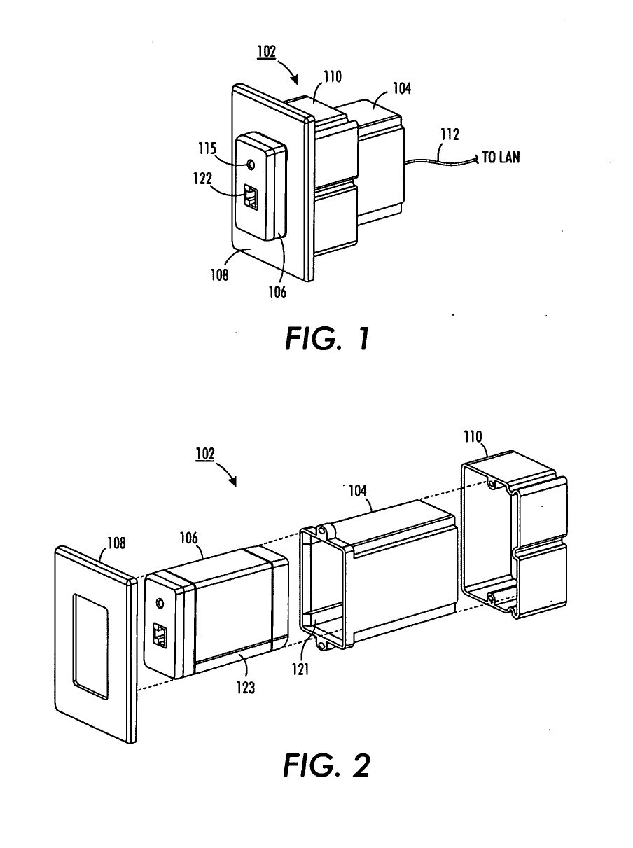

The access point module 102, for example in FIG. 1, consists of a mounting bracket 110, an network communication module, an application interface cartridge, and an optional wallplate. The network communications module receives and transmits data packets from a local area network (LAN) by handling the protocol conversions and data processing between the LAN and the application interface cartridge. In essence the network communications module handles the network centric electronics and firmware elements and co-exists within the access point with at least one of a variety of application interface cartridges 106. The appropriate (specific medium) application interface cartridge for the peripheral device is selected, inserted into, and electrically connected to, the forward facing cavity within the network communications module, which also serves as a chassis to position and secure one or more application interface cartridges. Each network communications module within the network is assigned a unique media access control (MAC) address that is fixed to that node and adopted by the inserted application interface cartridge, thereby eliminating the need to reconfigure the node. The network communications module may also store a security code such as a copy protection key (e.g., HDCP key code) that is associated with a network device.

As previously discussed, conventional access point wall enclosure practices require that only a connector be wired and inserted within a faceplate, however, as noted above, the device connector is now an integral part of the application interface cartridge, accordingly only a standard power outlet faceplate is required to provide an aesthetically “finished” appearance.

Currently limited network access point electronics and connectors have been housed within pre-existing low voltage enclosures, being less sophisticated than an ordinary electrical utility box, whereas the wires are simply hard wired and terminated into an access point connector or circuit board, absent any jack/plug configuration to the backbone. However, there is an evolving complexity to the access point wiring schemes, which encumbers such network installation, as well as subsequent module interchangeability, because hard connections are not intuitive or standardized. The present disclosure describes an access point that provides a “plug-and-play” configuration where one or more application interface cartridges can be interchanged without any rewiring or reconfiguration.

Requirements for an in-home network include high-speed data transfer for multimedia content, short-range connectivity for transfer to or between other devices, low power consumption due to limited current capacity, and low complexity and cost due to market pressures and alternative wired connectivity options. Accordingly, a complement of interchangeable application interface cartridge configurations may provide for interconnectivity with a wide gamut of consumer electronics network specifications, as well as any future configurations, at an acceptable cost to the end user. Although application interface cartridges share a common footprint they are functionally distinct in both connectors and data management. Application interface cartridges can be generally characterized into functional groupings such as; data, audio, video, and remote control, whereas each group is further identified as a receiver or transmitter (unidirectional) or as a transceiver (bidirectional). For example, an access point is configured using a specific application interface cartridge to accommodate the connection of the network communications module to a device such as a high definition television, as well as providing audio to a collection of speakers within the same backbone. Notably, as technology and client needs evolve, so will the availability of specific application interface modules in order to allow the end-user to take advantage of technical evolution without any significant effort or cost.

An access point may also be used in a configuration whereby the network communications module takes the form of a free-standing device. For example, one embodiment contemplates having the network communications module situated within a cradle that readily accepts an application interface cartridge. DC power may be provided via the connected LAN cable such as PoE for twisted pair cable or PoC for coax cable or from a local discrete power supply. Connectivity between a device and the network access point may be either hard wired or wireless. While a network address is assigned to the network communications module, due to the portability of the network communications module, address changes may be desired for the free-standing network communications module embodiment when plugged into an alternate location on the network as an access point.

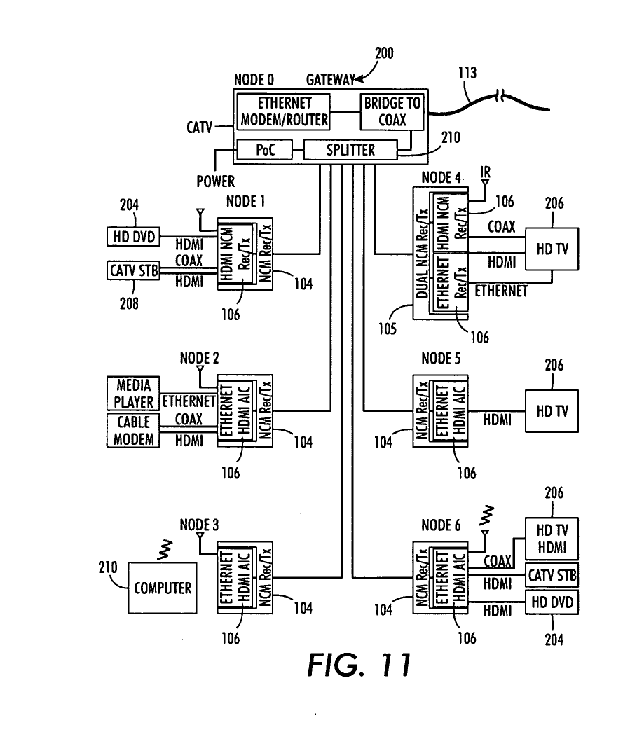

Referring also to FIG. 11, a LAN gateway 200 may be provided, at a service point of entry for phone/DSL, Satellite TV, Cable TV and the like to transition those signals onto the LAN and additionally provide other signal processing functions such as packet conversion/management. The gateway may also provide data bridge functions when it is desired to combine a mix of different LAN cabling types into one homogeneous network. The gateway also acts as a router that not only handles IP address assignments and security but also routes and distributes incoming and outgoing information from access point to access point as well as to/from the outside services.

Having generally described embodiments of the access point 102, attention is turned to FIGS. 1 and 2 for a more detailed description. Depicted therein is an access point (AP) 102 that provides an adaptable access port for a variety of network configurations (e.g. wired and/or wireless; computer, telephone, television, audio, etc), such as disclosed in Applicant's US Patents described above and previously incorporated by reference. Access point 102 enables the use of a single cable or multiple cables to distribute a plurality of exclusive protocols using various transmission media types. Alternatively, or in addition, access point 102 may provide a wireless access point, as in a Wi-Fi transceiver or repeater, and in some embodiments the access point itself may include an entire computer, or similar hardware for household security, surveillance, or similar applications.

Access point 102 includes two primary components, referred to above as the application interface cartridge (AIC) 106 and the network communications module (NCM) 104. The functionality of the network communications module is to provide a dedicated Media Access Control or MAC address as well as a data interface between the LAN and the application specific circuits located on the application interface cartridge. As seen in FIG. 2 network communications module 104 may be secured within a wall using a known low voltage in-wall mounting bracket 110. It will be appreciated that the bracket will include at least one means for mounting said bracket to a structure. Such means may include through-holes for screws or nails, or may include features such as tabs, grooves or the like on at least one outer surface that are designed to receive a screw, nail or other fastener so as to fasten the bracket to a stud or similar structural element, or to hold the bracket relative to a wall penetration (e.g., in a post construction installation). It is further contemplated that bracket 110 may be eliminated, wherein access point 102 is free-standing allowing it to be placed on a horizontal surface or hung on a wall surface, for example.

As further illustrated in FIG. 2, application interface cartridge 106 and network communication module 104 may have complementary guide rails 121 and channels 123, respectively, to engage one to another while directing the insertion of cartridge 106 into electrical connection with module 104. It will be appreciated that rails 121 and channels 123, or similar alignment features, may take various forms and positions, provided that they align with one another to facilitate a connection. Channels 123 may also include a detent that interacts with the rail to provide sufficient force to maintain the respective components in the connected position. In the alternative, in order to insure maximum integrity of the piggyback relationship, mounting holes are provided which securely hold cartridge 106 and module 104 in position in the same manner as faceplate 108 may be mounted to bracket 110.

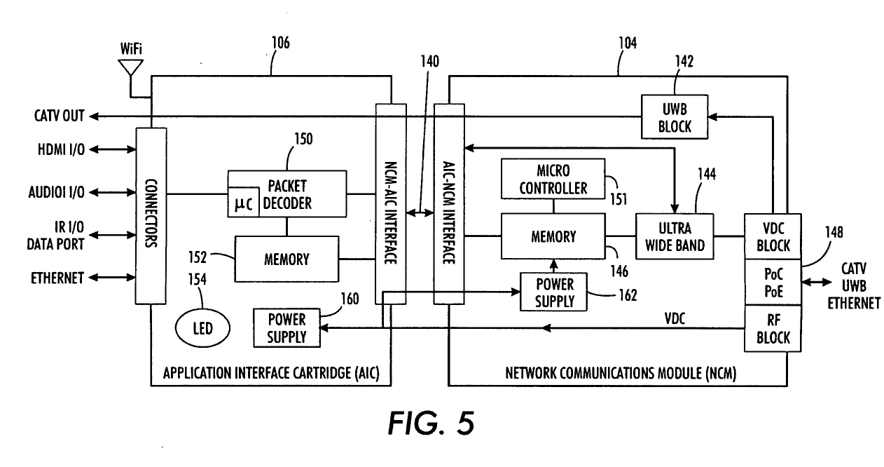

Network control module 104, when connected to the LAN via cable 112, provides for a static address assignment that will consistently associate a network address with the physical location of the module, which is not dependant, or specific to, a particular network peripheral device or application interface cartridge 106. Therefore the primary function of network communications module 104 is dependant on recognizing the address of its node on the network and accepting data accordingly when addressed. As shown in the block diagram of FIG. 5 and, module 104 may separate DC power from the data transmitted over the coax cable and further includes Ultra-wideband ASIC 144 (e.g., Pulse-Link chipsets) to support wired and wireless data transmissions and operate in the range of about 3.1 GHz to 6 GHz, at a power of approximately 41 dBm/MHz. More specifically, other means and methods may be used that employ different packet management schemes such as frequency division multiplexing at different frequencies such as in the 1 to 2.4 GHz ranges or in the ultra high microwave frequencies of 60 GHz and above. It will be appreciated that the embodiments may utilize alternative devices or chipsets depending upon the desired performance (e.g., Entropic, SiBeam, etc.)

One advantage of providing the components in a “piggy-back” configuration is to provide a standard receptacle, such as module 104, that includes the common support tasks, for example, a static IP address, receiving/transmitting data packets to/from the LAN and data processing, such as protocol conversions. Module 104 is further capable of receiving one or more application interface cartridges 106 thereby providing interchangeability, without necessitating an address update. Such a feature serves to accommodate a broad spectrum of network connected devices. For example, briefly referring to FIG. 11, six common network communications modules 104, having various application specific interface cartridges 106 inserted therein provide data to/from a plurality of distinct electronic devices. This attribute is of further advantage in a dynamic network environment where cartridge 106 is readily swapped, for example in a conference room or hotel where Wi-Fi might be generally interchanged with Ethernet, HD Video or possibly IR.

Faceplate 108 as viewed in FIG. 2 may be common for all configurations of application interface cartridge 106, and are commercially available as a utility outlet wall plate that is traditionally held in place with a pair of screws. The faceplate provides a trim accessory to cover the gap between module 104 and the mounting bracket 110, as well as between the chassis and the finished wall. Faceplate 108 may also be snapped onto bracket 110, either with a pressure/friction fit or a resiliently deformable lip that engages the frontal surface of bracket 110. It will be further appreciated that interlocking tabs or the like may be used so that faceplate 108 snaps into place and thereby provides a screw-less bezel that helps to hold access point unit 102 within bracket 110. Such faceplates of a screw-less designs are sold by Leviton™, Lutron™ and others. It will also be appreciated that various alternative means may be employed to attach faceplate 108 to bracket 110, cartridge 106 and/or module 104.

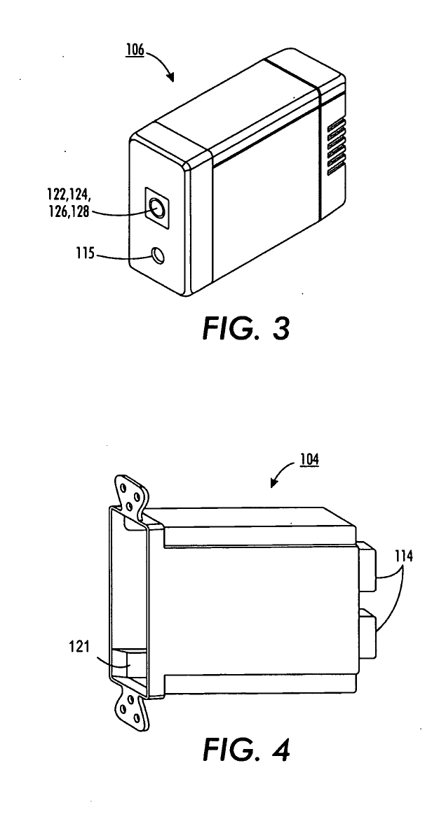

Now turning to FIGS. 3 through 5, the assortment of application interface cartridges 106 share a common external housing that encloses at least one circuit board with software/firmware to interface to at least one network electronic device including: digital video recorders, set top boxes 208, high definition televisions 206, DVD player/recorder 204, cable modem, media center PC, Internet access, Wi-FI, audio, personal computer 210, mass memory or various multi-media devices. The forward facing surface of application interface cartridge 106 includes one or more physical connections including, but not limited to, at least one of the following connectors; R/J-45, R/J-11, USB, Type F or N coax, CAT 5/6, HDMI, RS-232, DisplayPort, optical, IR, RF, Firewire, RCA plugs and similar connectors. Given the various connections available, one can readily appreciate the necessity for an application interface cartridge 106, not only to accommodate present connector demands, but also to remain compliant with future connection and interface specifications.

The circuits within application cartridge 106 may include a microcontroller (μC) as part of a packet decoder 150 to encode and/or decode packet data according to the rules specified by the firmware retained in either a memory or Field Programmable Gate Array (FPGA) 152. It will be appreciated that alternative types of memory or other means for providing programmatic control may be employed such as programmable read-only memory (PROM, EPROM, etc.), non-volatile random access memory (NVRAM), compact flash memory technology. Preferably, module 152 is capable of accepting and storing updated versions of software on an as needed basis to facilitate changes to the programmatic operation of the application interface cartridge. Intra-interface connection 140, between cartridge 106 and module 104, is contemplated to be based on industry standards, such as the Peripheral Computer Interface (PCI) or in the alternative the Personal Computer Memory Card International Association (PCMCIA) standard, however a proprietary high speed interface specification may be advantageous in the case where the IEEE standards are incompatible with cartridge 106 signal requirements. DC power is sourced from module 104 via the network and discriminated by RF/VDC block 148 and distributed to cartridge power supply 160 and module power supply 162 to provide the required voltage levels for the system. In the case of a fiber optic or other conductor unable to provide power, it may be necessary to provide “local” low voltage DC as a discrete power source for network communications module 104. Other conductors such as coaxial cable or CAT5, are able to receive power via the conductor (e.g., Power over Ethernet (PoE)). And, lastly, LED 154 is provided to identify the presence of power, as well as data transactions through application interface cartridge 106. Further contemplated is the ability of the application interface cartridge to provide a power forwarding capability, where on the application interface cartridge, power is available for consumer devices requiring power, such as USB, Firewire and Bluetooth devices.

Network communications module 104 serves as a receptacle (either in-wall or free-standing) for application interface cartridge 106 and as previously mentioned provides the generic support functions common to all categories of application interface cartridges 106. The network side of module 104 has at least one connector to accept data over a coax, twisted pair or optical conductor and as indicated above, cartridge 106 intra-connection 140 may be a peripheral component interconnect (PCI) or any other suitable connector that facilitates removable insertion of the cartridge 106 into module 104. Each module 104 is assigned and then identified by its own unique Media Access Control (MAC) address, which is a fixed address that is adopted by cartridge 106 and subsequently becomes the pseudo address for the network device.

Having an in-wall module provides for a permanent address to be associated with a specific location, such as the kitchen or family room, and as devices and cartridge 106 are replaced, the MAC remains stationary. Other circuit board components include an ultra-wide band (UWB) integrated circuit (IC) 144, which is an evolving RF technology that transmits binary data, without requiring a carrier frequency, by employing low-energy, pico-second bursts of radio frequency energy over a wide spectrum of frequencies and UWB block 142 serves to filter out the video data (CATV) from the UWB continuous wave data. Field programmable gate array (FPGA) 146 is, in one embodiment, the firmware that supports the physical layer of the OSI model and connects the hardware to a medium, such as optical fiber or copper cable for the purpose of sending and receiving a bit stream through the network. FPGA 146 further supports the transmission protocol and handles transmission errors, flow control and frame synchronization. Adding a programmable flash to the FPGA 146 in the application interface cartridge 106 allows features/upgrades to be added at a later date with minimal expense and effort by the user. An example would be to provide the user with an 802.11 Access Point interface cartridge that has most of the applications functionality provided for by the FPGA 146. Furthermore, there may be other functional blocks that are shared between multiple application interface cartridges. Instead of adding cost to each individual cartridge, it may be more efficient to move such functionality into the FPGA 146.

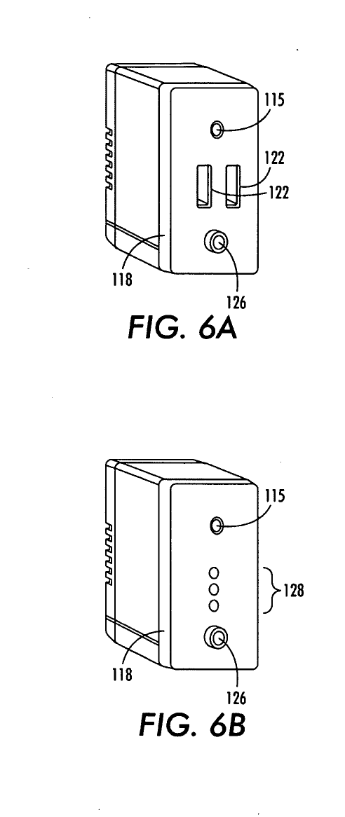

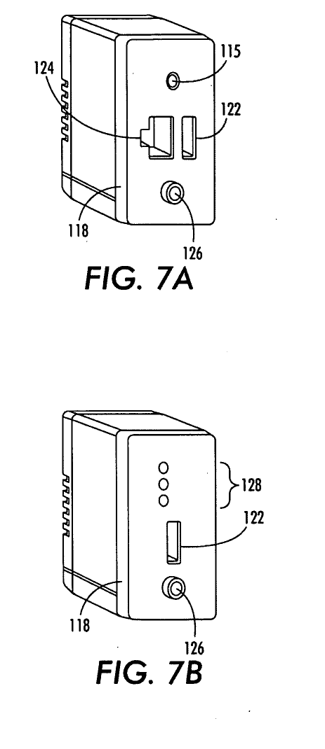

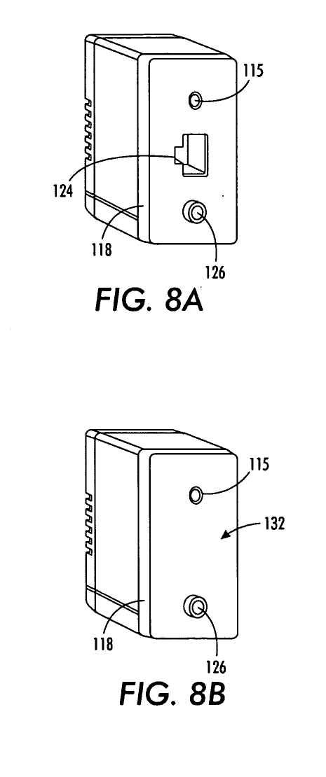

As seen in FIGS. 6A-8B, the front-facing surface of cartridge 106 provides for specific connector types to interface with the network and, in addition, may contain status indicator(s) 115 and/or ventilation/cooling slots 118. Although preferably concealed along the sides of the front surface, slots 118 may also be placed along the top and bottom and/or in other positions that would encourage the flow of air through cartridge 106 and within module 104 in order to provide cooling as may be required. Accordingly, thermal management is achieved within the chassis of module 104, without allowing the infiltration of air through an outside wall, as per Energy Star guidelines. FIGS. 6A-B illustrate two types of transmitting cartridges for placing HDMI format 122 or component video 128 onto a local network, whereas FIGS. 7A-B exemplify cartridges 106 that are intended to receive data, either HDMI 122, Ethernet 124 or composite video 128. FIG. 8A demonstrates the use of application interface module 106 as a high speed Ethernet transceiver port, either wired or wireless, or in the alternative, as in FIG. 8B where module 106 is simply a coax 126 pass through, without any application specific signal processing. As previously noted, faceplate 108, as viewed in FIG. 2 is preferably common for all 106 cartridge configurations. Nonetheless, the passive coax application interface cartridge may also be available in a decora format, and therefore will also accommodate the common utility outlet wall plate.

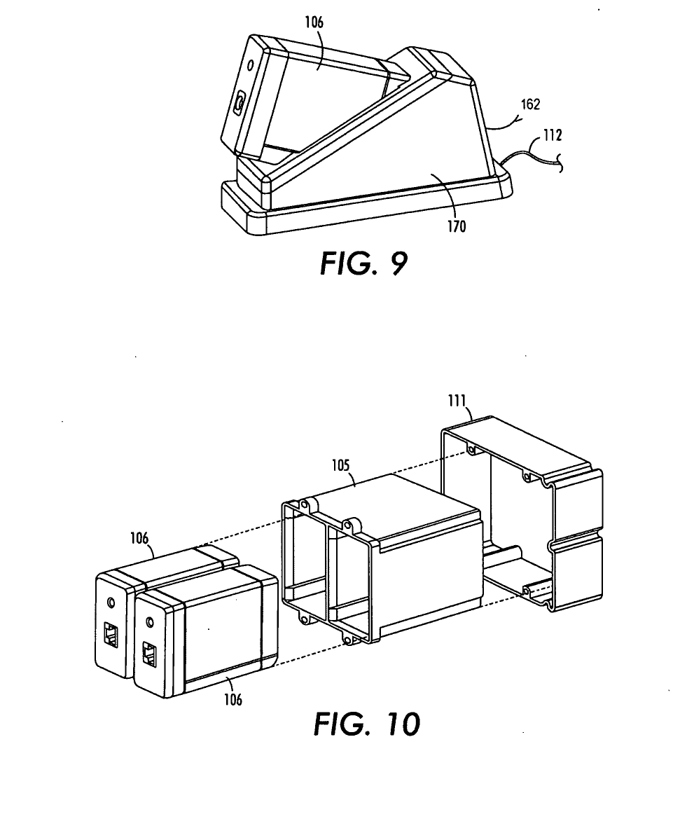

In an alternative embodiment depicted in FIG. 9, docking cradle 170 provides a configuration of the access point 102 when an in-wall location is undesirable or impractical. Such a situation may arise due to physical constraints such as available DC power, dimensions of low voltage enclosure, accessibility, wireless broadcast reception limitations and the like. Cradle 170 essentially provides the housing for the network communication module of access point 102 as a free-standing device whereby application interface cartridge 106 is selected, as above, from a plurality of available cartridge configurations. In operation, module 106 is inserted into network communications module residing within the housing of docking cradle 170. While multiple docking stations can be used, for convenience purposes such a docking station may also have a plurality of cradle positions to accommodate more than one application interface cartridge 106. DC power for cradle 170 may be provided via the connected LAN cable 112 or from a local discrete power supply via line 162.

Now turning to FIG. 10, a dual or duplex network access point 102 embodiment is shown whereby at least two access point units may be ganged together within a duplex rough in enclosure 111. Additionally, the dual configuration, as seen in FIG. 10, may have a single access point 102 positioned to accommodate the inclusion of an AC to DC power converter module that provides low voltage DC to module 104. The DC voltage may be derived from the adjacent AC source using conventional components such as transformers, voltage dividers and bridge diodes, all of which are contained within multi-position bracket 111.

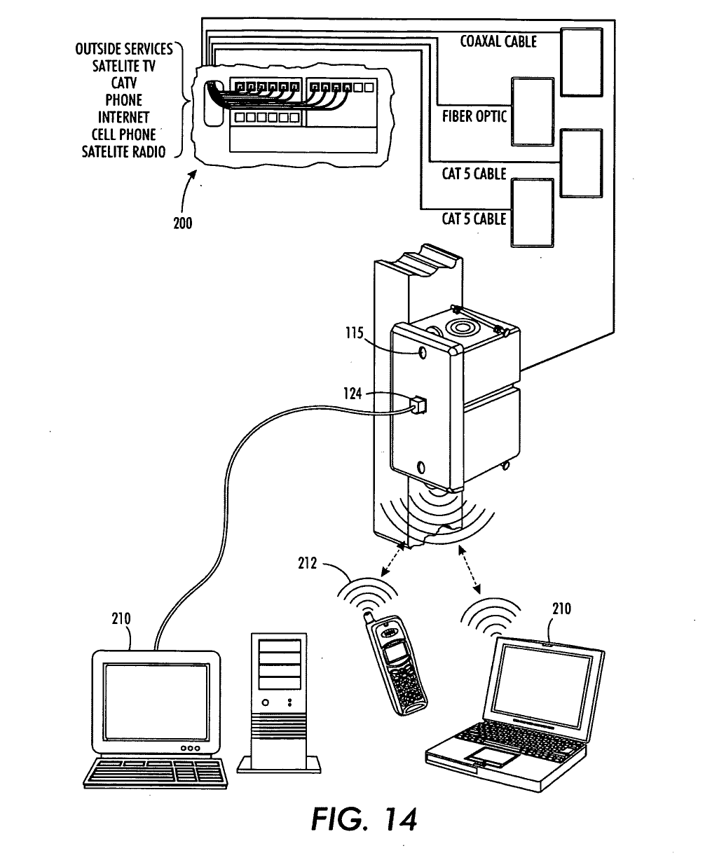

Referring next to FIGS. 11 and 14, depicted therein is an example of a home or building network using several types of access points 102. The physical network is depicted as coax cable, however twisted pair and fiber optics or alternatives, or any combination thereof is supported. In FIG. 11 it is shown where a multitude of cables are commonly collected, connected and terminated into splitter 210. The network cable connection means at cable 113 or transport cables 112 includes: crimp terminals, soldering, punch down block, screw terminal, insertion wire grip (as in AC outlets), ‘F’ type coaxial connectors, fiber optic termination connectors and any other means to electrically or optically bind the wire to a terminal of network communications module 104. Conveniently, now with the module 104, the network medium can comprise most any type of conductor and connector. This is a noteworthy feature of the disclosed embodiments because module 104 is intended to be standardized through the network, while cartridge 106 is specific to an application, therefore one generic module 104 will appropriately connect a plurality of function specific application interface cartridges 106.

As depicted, node 1 comprises module 104 with cartridge 106 inserted therein having HDMI and coax connections to a DVD player/recorder 204 and a set top box while node 2 is directed towards a media player, possibly in the living room and a cable MODEM which facilitates internet access for example. Node 3 supports a bi-directional wireless interconnect to a computer 210 and is either RF or IR dependent. Node 4 is most typical of a home theater application where two module 104 are in place to support video streaming via Ethernet and local HDMI video/audio from the Node 1 HD DVD 204, as well as HD 5.1 audio out through coax to remote speakers. Moving down to node 5 there is a representative network configuration for high definition television 206 directly from gateway 200 or any HDTV source within the LAN, such as node 1 and 6, where node 6 includes a HDTV along with a set top box and DVD player 204.

In order to complete the multi-access network system the local area network requires connectivity to the wide area network by means of gateway 200 or node 0 which manages the incoming and outgoing signal transmissions and associated protocols. Gateway 200 directly connects to the Multiple Services Operator (MSO) point of entry and may provide for a cable MODEM, amplifier and routing facility to each of the addressable nodes within the LAN. Additionally, gateway 200 is accountable for automatically handling address assignments, configuration and security provisions for each network communications module 104 as nodes are added to the network. The gateway may further include memory to store and manage addressing of the network access points. Gateway 200 also has provisions for introducing a direct current voltage onto the coax or twisted pair network conductors in order to provide circuit power for the electronics contained within access points 102. As mentioned previously, the gateway 200 provides medium bridging functions for mixed medium networks and in general the packet management activities between all access points on the network.

While not referenced in FIG. 11 there are a variety of “housekeeping” activities that may interact along the backbone as well, such as lighting, intercoms, surveillance cameras, motion detectors and other security devices, home theater, amplifiers, HVAC sensors/controls and additional energy management devices, to name a few.

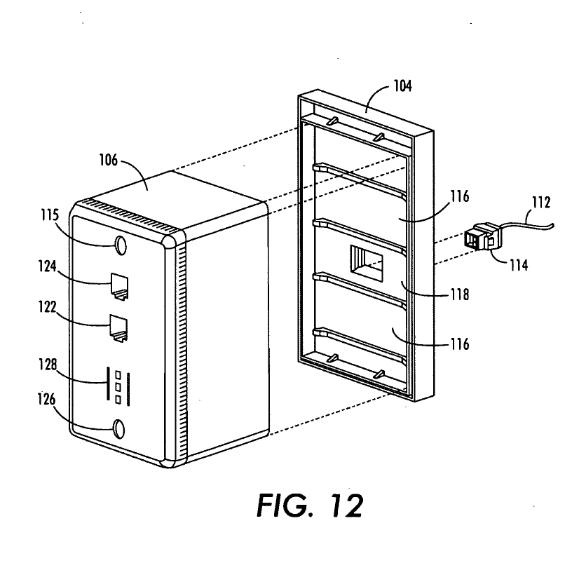

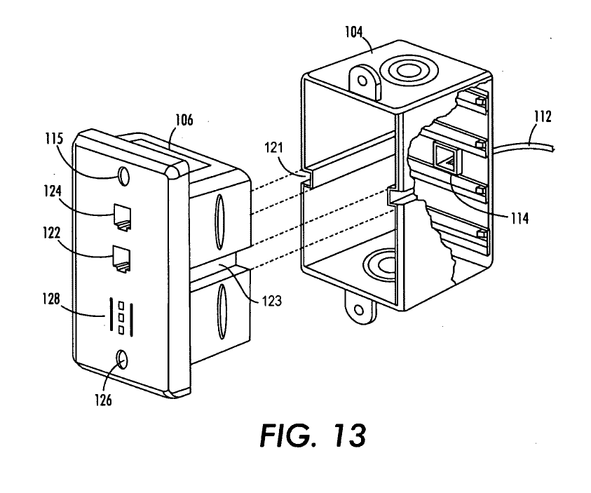

Lastly, turning to FIGS. 12 and 13, depicted therein is an access point that provides an adaptable access port for a variety of communications connection requirements. Module 102 enables the use of a single cable or multiple cables to distribute a plurality of unique signals (and protocols) within a multiplicity of cable types. Module 102 is designed to directly mate or interface with backplane 120 while engaging with modular connector 114. During a typical installation of a network, each access point wire is terminated into a connector that is securely mounted within the access point so a network access device may subsequently be connected into the network. The connector may or may not include industry standard terminations, however with module 102 inserted into backplane 120, located between the network connection and an electronic device, it is advantageous to have module 102 contained within chassis 126, to interface with various connector types as the module 102 is guided into backplane 120 and connector 114.

In recapitulation, the present invention is a method and apparatus for providing a “plug and play” network access point, which traditionally only comprises a rough-in enclosure to simply mount a connector. In accordance with the invention a traditional rough-in enclosure will now provide for the in-wall mounting of a network access point unit 102 comprising a general purpose network node communications module 104 having provisions for the insertion of at least one of a variety of application interface modules 106 to accommodate a specific group of network dependant devices, be it audio, video or data. Accordingly, integrating structured access point functions into a network having a centralized control system, that coordinates and moves packets to and from the access point, accounts for a network system that is not medium or protocol dependant. This provides for a cost-effective and versatile infrastructure for both existing and new construction that is forward compatible to the connectivity demands of evolving technologies.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A network access point, comprising:
at least one network communications module;
at least one application interface cartridge, inserted within said network communications module, wherein said network communication module and said application interface cartridge, in combination, comprise a network access point; and
at least one physical medium conductor connected to said access point and arranged for connection to at least one other access point.

2. The network access point according to claim 1, further comprising a retaining bracket for securing said network communications module to a structure.

3. The network access point according to claim 1, further comprising a free-standing housing in which said network communications module is located.

4. The network access point according to claim 1, wherein said network communications module is connected to at least one transport medium selected from a group consisting of: twisted pairs; fiber optic; coaxial cable; power line, and wireless.

5. The network access point according to claim 4, including a plurality of data transport medium.

6. The network access point according to claim 1, wherein the access point connector of the application interface cartridge comprises a fiber optic connector.

7. The network access point according to claim 1, wherein the access point connector of the application interface cartridge is a coaxial type connector

8. The network access point according to claim 1, wherein the access point connector of the application interface cartridge comprises an Ethernet connector.

9. The network access point according to claim 1, wherein the access point connector of the application interface cartridge is selected from the group consisting of: a video connector; an audio connector; a data connector; and a remote-control connector.

10. The network access point according to claim 1, wherein the access point connection of the application interface cartridge comprises an antenna supporting wireless communication.

11. The network access point according to claim 1, wherein the application interface cartridge includes an interconnecting cable.

12. The network access point according to claim 1, wherein the network communications module includes a media converter.

13. The network access point according to claim 1, wherein the application interface cartridge includes a media converter.

14. The network access point according to claim 1, wherein the access point connections of the application interface cartridge comprises a plurality of device specific connectors.

15. The network access point according to claim 1, wherein the network communications module stores a distinctive network address that is associated with a network device.

16. The network access point according to claim 1, wherein the network communications module stores a security code associated with a network device.

17. The network access point according to claim 2, wherein said bracket retains a plurality of network access points.

18. The network access point according to claim 1, wherein the application interface cartridge engages a connector upon insertion into the network communications module

19. The network access point according to claim 1, wherein the network communications module receives a plurality of application interface cartridges therein.

20. The network access point according to claim 2, wherein said bracket is a low voltage rough-in enclosure.

21. The network access point according to claim 2, wherein said bracket is a high voltage rough-in enclosure.

22. The network access point according to claim 4, including a network communication module that obtains power from the transport medium.

23. The network access point according to claim 4, further including a discrete power source, said power source providing power for at least said network communication module.

24. The network access point according to claim 2, further including a faceplate, wherein said faceplate, in combination with the application interface cartridge, provides a continuous frontal surface on the network access point.

25. The network access point according to claim 1, further including ventilation ports for cooling the combined network communications module and the application interface cartridge.

26. The network access point according to claim 1, further including cooperating guides to register the application interface cartridge within the network communications module.

27. A method of creating an access point within a network, comprising:
connecting a network communication module, having a dedicated network address, to said network;
inserting an application interface cartridge within the network communication module; to electrically engage the network communication module and thereby complete a network access point providing a device interface for connection of a user device to the network.

28. The method according to claim 27, wherein inserting said application interface cartridge comprises inserting the cartridge into an enclosure associated with the network communication module, said module having guides to subsequently direct the cartridge into contact with said module.

29. The method according to claim 27, wherein connecting a network communications module further comprises attaching a network cable to a backplane of said network communications module.

30. A network, including:
a gateway; and
a network access point, connected to said gateway, comprising
at least one network communications module,
at least one application interface cartridge, inserted within said network communications module, wherein said network communication module and said media-specific adapter, in combination, comprise a network access point, and
at least one physical medium conductor connected to said access point and arranged for connection with said gateway.

31. The network according to claim 30, wherein said gateway provides power to said network access point via the physical medium.

32. The network according to claim 30, wherein said gateway further includes memory to store and manage addressing of said network access point.
